(19) United States
(12) Patent Application Publication
(10) Pub. No.: US 2007/0200654 A1
(43) Pub. Date: Aug. 30, 2007

(54) Non-Inductive Winding Wire-Type Solenoid Bobbin

(75) Inventors: Seong-Eun Yang, Seoul (KR); Min-Choel Ahn, Paju-si (KR); Dong-Keun Park, Seoul (KR); Tae-Kuk Ko, Seoul (KR)

Correspondence Address: SHERIDAN ROSS PC, 1560 BROADWAY, SUITE 1200, DENVER, CO, 80202, US

(73) Assignee: Industry-Academic Cooperation Foundation Yonsei University

(21) Appl. No.: 11/567,615

(22) Filed: Dec. 6, 2006

(30) Foreign Application Priority Data
Feb. 28, 2006 (KR) 10-2006-0019184

(51) Int. Cl. H01F 6/00

(52) U.S. Cl. 335/216

(57) ABSTRACT

Disclosed herein is a non-inductive winding wire-type solenoid bobbin. The bobbin includes a cylindrical bobbin body, winding grooves formed on an outer circumferential surface of the bobbin body at regular intervals, and a connection channel provided on one side of each of the winding grooves. According to the present invention, an inner wire is in direct contact with liquid nitrogen through the connection channel, thus increasing the cooling effect when an electrical power system experiences trouble, and a superconducting fault current limiter including the bobbin limits a current, therefore minimizing damage to the inner wire, and makes a fast recovery after the fault current is limited to allow the current to resume flowing in the system.

### CROSS-REFERENCE TO RELATED APPLICATION

This application claims priority to and the benefit of Korean Patent Application No. 10-2006-0019184 filed with the Korean Intellectual Property Office on Feb. 28, 2006, the entire content of which is incorporated herein by reference.

### BACKGROUND OF THE INVENTION

1. Field of the Invention

The present invention relates to a non-inductive winding wire-type solenoid bobbin, which improves the cooling effect of a bobbin applied to a resistance-type high temperature superconducting fault current limiter so as to reduce the fault current caused by a short circuit or a ground fault in of a large electrical power system.

2. Description of the Related Art

As is well known to those skilled in the art, a fault current limiter is a kind of circuit breaker that has no impedance under normal conditions, but when an abnormal voltage or current flows in an electrical power system due to a fault, such as lightning or a short circuit, impedance is rapidly generated, thus limiting a fault current and preventing various power apparatuses installed in the system from breaking or being damaged. Such present fault current limiters lead to power outages by completely cutting the supply of electricity. Conversely, a superconducting fault current limiter is a new power apparatus that changes a high fault current into a normal current using the characteristics of superconductivity, thus permitting normal operation without a power outage even if a fault occurs.

Superconduction is a phenomenon in which electrical resistance disappears at 4K, which is slightly higher than an absolute zero, such as when mercury is cooled with liquid helium.

A resistance-type fault current limiter is a limiter to which AC power is directly applied. When an electrical power system experiences trouble, the limiter generates resistance accompanied by heat generation which is caused by a phase transition for limiting the fault current.

Such a fault current limiter generates heat when a fault occurs. A conventional non-inductive winding wire-type solenoid bobbin is problematic in that no device is provided to mitigate the difference in cooling condition between an outer wire and an inner wire, so that the inner wire may be damaged by the heat when an excessive voltage is applied.

At an extremely low temperature, when the bobbin is thermally contracted, mechanical stress is concentrated in a region at which current enters a superconductive magnet, thus generating mechanical vibrations and heat, therefore quenching superconductivity and/or breaking the wire.

A conduction-cooling-type superconducting electromagnet having no refrigerant is especially problematic in that heat caused by mechanical vibrations is not eliminated, so that superconductivity is quenched.

In order to overcome the above problems, various types of bobbins have been developed. For example, Korean Patent No. 0429777 discloses a bobbin for a superconductive magnet using a GM cryocooler. The bobbin includes a bobbin unit, a thermal capacitor, conductive cooling rods, rod-type wires, and a pair of diodes. The bobbin unit includes a central insulating part, upper and lower conducting parts which are fastened, at one end of each of the upper and lower conducting parts, to the insulating part and have at the other end thereof a frame, and a superconductive coil wound around the upper and lower conducting parts such that both ends of the coil are secured to the frames. Further, the elongated thermal capacitor is secured, at an upper end of one side thereof, to the lower end of the head of the GM cooler in such a way as to be perpendicular to the head. One end of each of the conductive cooling rods is coupled to the other side of the thermal capacitor, with an insulating member interposed between the conductive cooling rods and the thermal capacitor. The other end of each conductive cooling rod is coupled to each frame of the bobbin unit. The electrical wires, serving as the incoming current supply, are coupled to the corresponding frames so as to apply power from a power source to the bobbin unit. The diodes are coupled to protruding parts which are provided at predetermined positions on the frames parallel to each other.

However, in the case where the bobbin is applied to a distribution superconducting fault current limiter, superconductive wires are layered or are arranged to have several parallel structures, because the normal operating current is large. Thus, it is difficult to efficiently eliminate internal heat using a refrigerant.

Further, Korean Patent No. 0521573 discloses a bobbin for a superconductive magnet. The bobbin is coated with an FRP coating layer having spiral winding grooves provided on an outer circumferential surface thereof at regular intervals and form layers. A plate-type electrical wire is wound in each layer of the spiral winding groove to fill the winding groove. Thereafter, each layer is divided into upper and lower parts, thus forming a double winding layer. Spacers are provided in the plate-type electrical wire forming the double winding layer and between each of the double winding layers.

Further, Korean Patent No. 0378886 discloses a superconducting persistent current switch and a bobbin therefor. The switch includes a cylindrical bobbin body for winding a superconductive wire or a heater wire, and flanges provided on both sides of the bobbin body. Each flange includes a winding wire introduction hole, a circular guide groove having a predetermined depth, a wire discharging aperture, a discharging wire guide groove, a heater wire discharge hole, and a discharging heater wire guide groove. The wire introduction hole allows an end of the superconductive wire from the exterior of the flange to enter the bobbin body. The circular guide groove is formed on the outer surface of the flange in a circular shape, and has the wire introduction hole as a starting point and a terminating point. The wire discharging aperture is cut from the outer surface of the flange to a predetermined length. The discharging wire guide groove starts from the end of the wire discharging aperture, is at a predetermined angle with respect to the aperture, and is formed on the outer surface of the flange in the direction of the outer circumferential surface. The heater wire discharge hole is formed to allow the end of the wound heater wire the bobbin body to the outside of the flange. The discharging heater wire guide groove starts from the heater wire discharge hole, and is formed on the outer surface of the flange in the direction of the outer circumferential surface.

However, the above methods are problematic in that the inner wire cannot be efficiently cooled, and a BSCCO wire having a width of 4 mm is used, so that it is difficult to form a hole for contacting a refrigerant in a groove of 4 mm. Further, even though the hole is formed, the contact area of the refrigerant with the wire is small, so the cooling effect is low.

### SUMMARY OF THE INVENTION

Accordingly, the present invention has been made keeping in mind the above problems occurring in the prior art, and an object of the present invention is to provide a non-inductive winding wire-type solenoid bobbin, which is constructed so that a connection channel that extends to the interior of a cylindrical bobbin body is provided on a groove in which an inner wire is disposed, thus allowing the inner wire to be in direct contact with liquid nitrogen, therefore increasing a cooling effect, limiting a fault current and achieving a rapid recovery speed.

In order to accomplish the above object, the present invention provides a non-inductive winding wire-type solenoid bobbin, including a cylindrical bobbin body, winding grooves formed on an outer circumferential surface of the bobbin body at regular intervals, and a connection channel provided on one side of each of the winding grooves.

According to the present invention, the bobbin body has the shape of a hollow cylinder. Any material may be used for the bobbin body, as long as the material is not affected by a magnetic field. Preferably, the bobbin body is made of glass fiber reinforced plastic or insulated aluminum.

The winding grooves of the present invention are formed along the outer circumferential surface of the bobbin body to form layers at regular intervals, so that a wire is wound in the winding grooves. Preferably, the grooves are arranged in a spiral arrangement. The number of layers may vary according to requirements, and the width and the depth of the layers are set to correspond to the width and depth of the electrical wire to be wound around the bobbin.

Connection channels according to the present invention are provided on one side of each winding groove at regular intervals, thus serving as a passage for cooling the inner wire wound in the winding groove. The size of each connection channel is smaller than the width of the winding groove. Preferably, the size of the connection channel is set to allow refrigerant to easily flow.

Further, each connection channel of the present invention preferably has a support part to maintain the shape of the bobbin and prevent the bobbin from being depressed by the connection channel.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a perspective view showing a bobbin according to the present invention;

FIG. 2 is a sectional view of the bobbin according to the present invention; and

FIG. 3 is a sectional view of part of the bobbin according to the present invention.

### DESCRIPTION OF THE PREFERRED EMBODIMENTS

Hereinafter, the present invention will be described in detail with reference to the accompanying drawings. It is to be understood that the present embodiment is illustrative and not restrictive.

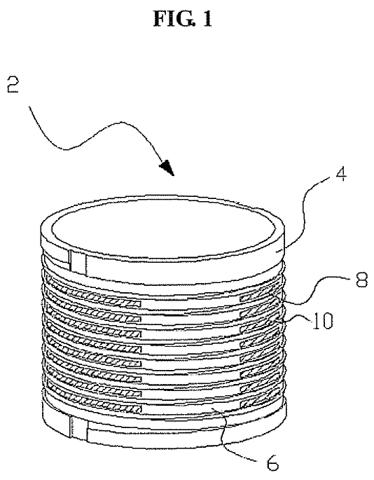

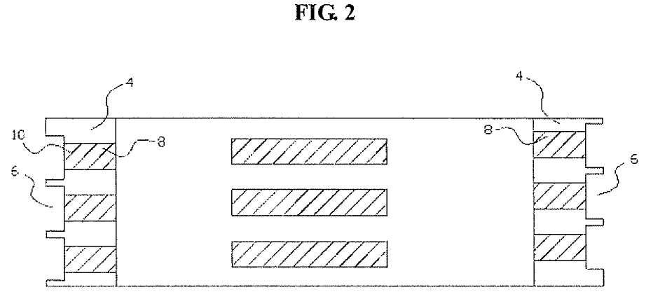

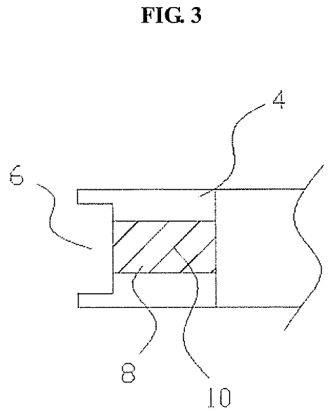

FIG. 1 is a perspective view showing a bobbin according to the present invention, FIG. 2 is a sectional view of the bobbin according to the present invention, and FIG. 3 is a sectional view of part of the bobbin according to the present invention.

As shown in FIGS. 1 to 3, a non-inductive winding wire-type solenoid bobbin 2 according to the present invention includes a bobbin body 4, winding grooves 6, and connection channels 8.

In this case, the bobbin body 4 serves to provide a place for winding a superconductive wire or the like. The bobbin body 4 has the shape of a hollow cylinder. Any material may be used for the bobbin body 4, as long as the material is not affected by magnetic fields. Preferably, the bobbin body 4 is made of glass-fiber reinforced plastic or insulated aluminum.

The winding grooves 6 of the present invention preferably comprise grooves which are formed on the outer circumferential surface of the bobbin body 4 at regular intervals to form layers, and have a predetermined depth. Preferably, the winding grooves 6 are arranged in a spiral arrangement. The number of winding grooves 6 is variable. Preferably, the number of winding grooves 6 is 2 to 20. More preferably, the number of winding grooves 6 is 5 to 10. The width and the depth of each winding groove 6 is determined according to the width and the thickness of the electrical wire to be wound around the bobbin. Preferably, each winding groove 6 has a width of 4 cm or more.

For example, a high-temperature superconducting electrical wire (Wire Type PN0002831), which is manufactured by the ASC (American SuperConductor) company and is a plate-type wire adapted to the present invention, has a thickness of 0.4 mm and a width of 4.1 mm. Thus, each winding groove 6 preferably has a width suitable for accommodating one electrical wire therein, that is, about 4.2 mm. The depth of the winding groove 6 is preferably set to allow the plate-type wire to be wound once. That is, the winding groove 6 has a depth of 0.4 mm. However, the width and the depth of each winding groove 6 may be changed according to the kind of electrical wire used.

Preferably, each connection channel 8 of the present invention is provided on one side of the winding groove 6 to be open, so that liquid nitrogen passes through the connection channel 8, thus cooling the inner wire. Each connection channel 8 preferably has a width that leaves enough space to support the wire in the winding groove 6. The interval between the connection channels 8 is preferably a distance flat prevents the supporting capacity of the bobbin from deteriorating, and allows the inner wire to be easily cooled by a refrigerant.

As an example, when each winding groove 6 for winding has a width of 4 cm, the connection channel 8 preferably has a width of about 3 cm, leaving a space of 1 cm to support the wire.

Further, when holes are formed in all surfaces on which the wire is wound, the supporting capacity of the bobbin may deteriorate. Thus, it is preferable that a support part 10 be installed in each connection channel 8, thus supporting the bobbin 2.

Although the preferred embodiment of the present invention has been disclosed for illustrative purposes, those skilled in the art will appreciate that various modifications, additions and substitutions are possible, without departing from the scope and spirit of the present invention as disclosed in the accompanying claims.

As described above, the present invention provides a non-inductive winding wire-type solenoid bobbin, in which an inner wire is in direct contact with liquid nitrogen through a connection channel, thus increasing the cooling effect when an electrical power system experiences a fault, and a superconducting fault current limiter including the bobbin limits a current, therefore minimizing damage to the inner wire, and make a fast recovery after the fault current is limited to allow the current to resume flowing in the system.

What is claimed is:

1. A non-inductive winding wire-type solenoid bobbin, comprising:
a cylindrical bobbin body;
two or more winding grooves formed on an outer circumferential surface of the bobbin body at regular intervals; and
at least one connection channel provided on one side of each of the winding grooves.

2. The non-inductive winding wire-type solenoid bobbin as set forth in claim 1, wherein a support part is provided in the connection channel.
